(19) United States
(12) Patent Application Publication
(10) Pub. No.: US 2002/0132503 A1
(43) Pub. Date: Sep. 19, 2002

(54) Shield connector

(75) Inventors: Eiji Murofushi, Shizuoka (JP); Takayuki Kato, Shizuoka (JP)

Correspondence Address: SUGHRUE MION, PLLC, 2100 Pennsylvania Avenue, NW, Washington, DC, 20037-3213, US

(73) Assignee: YAZAKI CORPORATION

(21) Appl. No.: 10/095,112

(22) Filed: Mar. 12, 2002

(30) Foreign Application Priority Data
Mar. 13, 2001 (JP) P2001-70770

(51) Int. Cl. H01R 4/66

(52) U.S. Cl. 439/98

(57) ABSTRACT

A shield connector (47) for connecting a braid (37C) of a shielded wire (37) to a metal casing of an equipment includes a connector housing (47), and this connector housing includes a tubular body (17) which has a bracket (15) for mounting directly on the metal casing of the equipment, and can be electrically connected to the braid (37C) of the shielded wire while covering an end portion of the shielded wire (37). The connector housing is made of a metal composite material comprising lightweight metal (51) and hollow ceramics grains (53).

### BACKGROUND OF THE INVENTION

This invention relates to a shield connector, and more particularly to a lightweight design of a shield connector for connecting a braid of a shielded wire (or cable) for an electric vehicle to a metal casing of an equipment.

In order to block electrical noises such as electromagnetic waves and static electricity, a conventional shielded wire, used as a high-voltage wire for an electric vehicle, is of such a construction that conductors covered with an insulating inner covering, are covered with a braid, and this braid is covered with a sheath in an insulated manner.

One example of shield connectors for connecting the braid of such a shielded wire to a metal casing of an equipment for grounding purposes is disclosed in JP-A-11-126656.

Namely, as shown in FIG. 3, this shield connector 1 comprises a connector housing 3 made of metal, a short-circuiting member 5 made of metal, a seal rubber 7 made of rubber, a corrugated tube 9 made of a synthetic resin, a corrugated tube holder 11 made of a synthetic resin, and an O-ring 13 made of rubber.

The connector housing 3 has a generally cylindrical shape, and is open at its opposite ends, and the whole of this connector housing is made of lightweight metal, such as aluminum, so that it can have good electrical conductivity, sufficient strength and so on. Copper plating is applied as an undercoat to the connector housing 3 over an entire surface thereof, and further tin plating is applied to this undercoat. With this construction, the electrical conductivity is enhanced so as to achieve the more positive shielding.

A bracket 15 is formed integrally on an outer surface of a body 17 of the connector housing 3, and the connector housing 3 can be mounted directly on a metal casing of an equipment (not shown) by fastening this bracket by a bolt.

A mounting groove 21 for the O-ring 13 is formed in an insertion portion 19 of a smaller diameter formed at a distal end of the connector housing 3. When the insertion portion 19 is inserted into an insertion hole, formed in the metal casing of the equipment, the O-ring 13 forms a watertight seal between the insertion portion 19 and the insertion hole.

In the shield connector 1 of the above construction, a shielded wire 37, subjected to end processing, is passed through the short-circuiting member 5, and this short-circuiting member is compressed to fix a braid 37C, and when the shielded wire 37 is passed through the connector housing 3, the short-circuiting member 5 is brought into contact with the connector housing 3 to be electrically connected thereto.

Then, the seal rubber 7, through which the shielded wire 37 is passed, is provisionally inserted into the connector housing 3, and then the shielded wire 37 is passed through an assembly comprising the corrugated tube 9 and the corrugated tube holder 11. The corrugated tube holder 11 is split into two halves, that is, comprises a pair of half covers 11A and 11B. When these half covers are combined together into a unitary condition, their distal end surfaces jointly form a press contact surface 45 which is generally equal in diameter to the seal rubber 7.

Then, this corrugated tube holder 11 is press-fitted into the connector housing 3. Thereafter, the O-ring 13 is mounted in the mounting groove 21 in the connector housing 3, thus completing the assemblage of this shield connector 1.

When the bracket 15 of the connector housing 3 is mounted directly on the metal casing of the equipment (not shown), the braid 37C of the shielded wire 37 is connected for grounding purposes to the metal casing of the equipment via the short-circuiting member 5 and the connector housing 3.

In the case of using the above shield connector 1 on a shielded wire for an electric vehicle, it has been desired to achieve a more lightweight design of the shield connector so as to reduce the weight of the vehicle to thereby enhance the running performance thereof, and it has also been desired to reduce the cost of the shield connector.

### SUMMARY OF THE INVENTION

It is therefore an object of this invention to solve the above problems, and more specifically to provide a shield connector which is inexpensive, and can be formed into a more lightweight design.

In order to solve the aforesaid object, the invention is characterized by having the following arrangement.

(1) A shield connector for connecting a braid of a shielded wire to a metal casing of an equipment, the shield connector comprising:

a connector housing including,

a mounting portion for mounting directly on the metal casing, and

a tubular body capable of covering an end portion of the shielded wire so as to be electrically connected to the braid of the shielded wire,

wherein the connector housing is made of a metal composite material comprising lightweight metal and hollow ceramics grains.

(2) The shield connector according to (1), wherein the volume content of the hollow ceramics grains relative to the total volume of the connector housing is 30% to 60%.

(3) The shielded connector according to (1), wherein the connector housing is produced by a method in which the hollow ceramics grains and molten light weight metal are mixed together, and the mixture is cast.

(4) The shielded connector according to (1), wherein the connector housing is produced by a method in which the hollow ceramics grains are preformed into a shape of the connector housing, and the preform is impregnated with molten lightweight metal.

(5) The shielded connector according to (1), wherein the connector housing is produced by a method in which a lightweight metal billet, containing the hollow ceramics grains, is beforehand formed, and the billet in a half-molten state is processed.

In the above construction, the connector housing is made of the metal composite material comprising the lightweight metal (such as aluminum, an aluminum alloy or a magnesium alloy) and the hollow ceramics grains which are lightweight and inexpensive, and therefore the lightweight design can be achieved while securing the necessary mechanical strength, and besides the production cost can be reduced.

Therefore, the lightweight design of the electric can be achieved by using the shield connector of the lightweight design.

### BRIEF DESCRIPTION OF THE DRAWINGS

FIG. 1 is an exploded, perspective view of one preferred embodiment of a shield connector of the present invention.

FIG. 2 is a longitudinal cross-sectional view of the shield connector of FIG. 1.

FIG. 3 is an exploded, perspective view of a conventional shield connector.

### DETAILED DESCRIPTION OF PREFERRED EMBODIMENTS

One preferred embodiment of a shield connector of the present invention will now be described in detail with reference to the accompanying drawings.

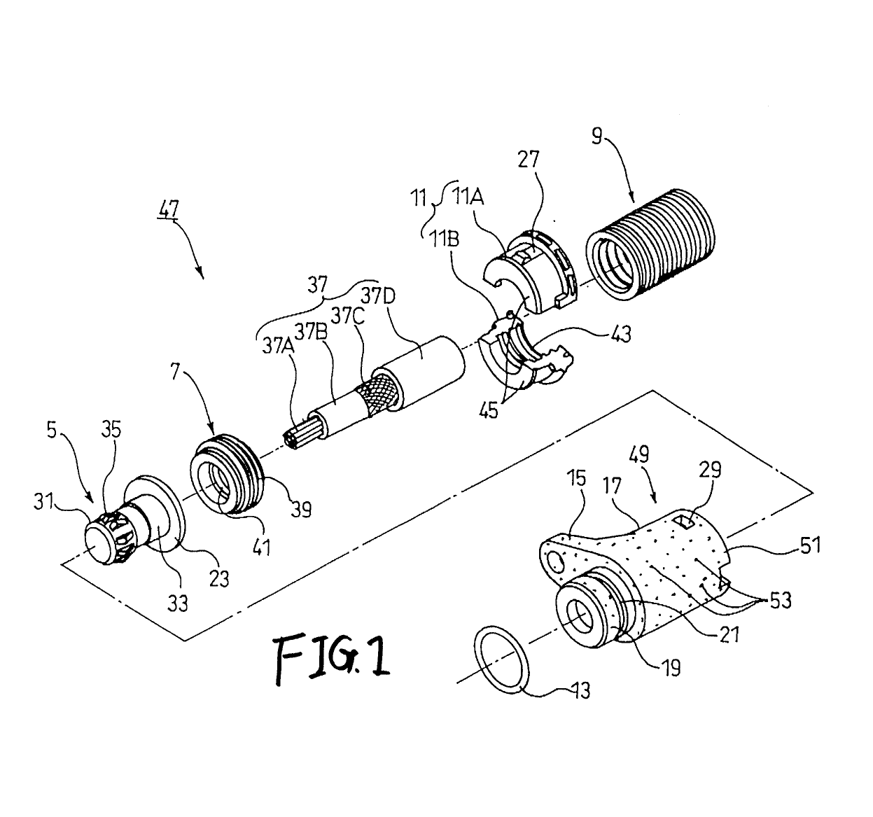

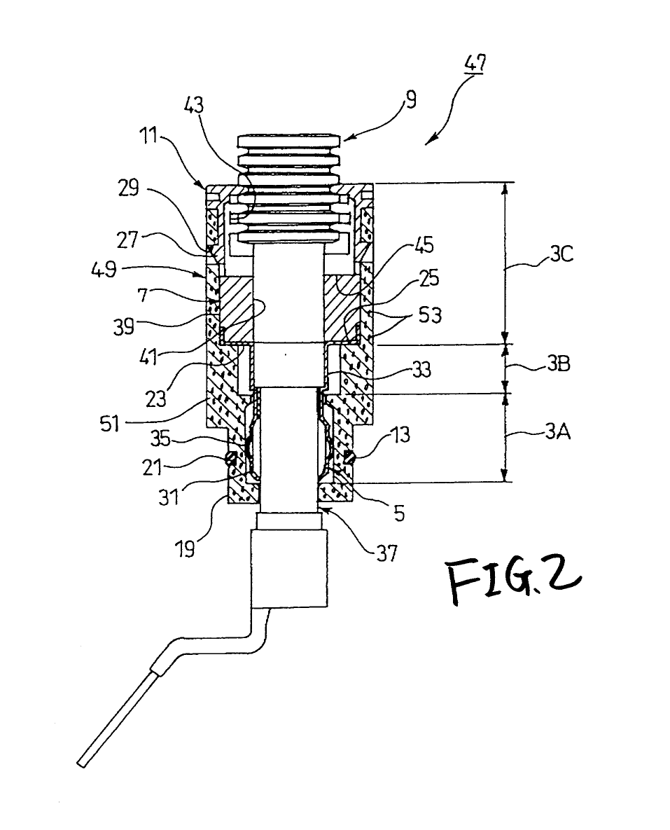

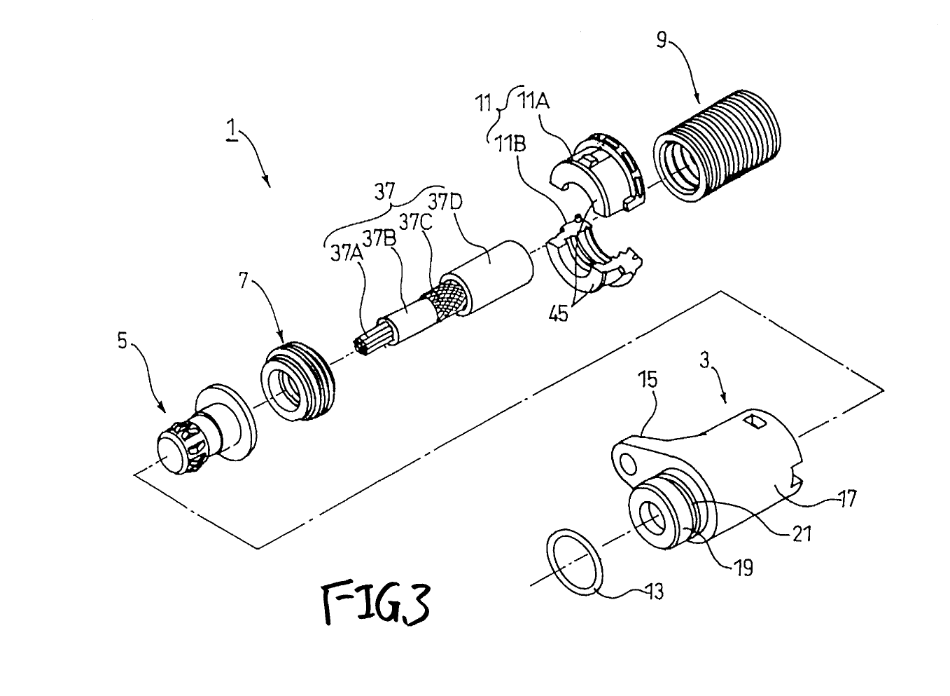

FIGS. 1 and 2 are an exploded, perspective view and a longitudinal cross-sectional view of one embodiment of the shield connector of the invention, respectively. Most of the construction of the shield connector 47 of this embodiment is the same as that of the conventional shield connector 1 shown in FIG. 3.

As shown in FIGS. 1 and 2, the shield connector 47 of this embodiment comprises a connector housing 49 made of a metal composite material, a short-circuiting member 5 made of metal, a seal rubber 7 made of rubber, a corrugated tube 9 made of a synthetic resin, a corrugated tube holder 11 made of a synthetic resin, and an O-ring 13 made of rubber.

The connector housing 49 has a generally cylindrical shape, and is open at its opposite ends, and this connector housing is made of the metal composite material comprising lightweight metal 51 and hollow ceramics grains 53 of which cost is low. Copper plating is applied as an undercoat to the connector housing 49 (made of the metal composite material) over an entire surface thereof, and further tin plating is applied to this undercoat. With this construction, the sufficient strength and the enhanced electrical conductivity are obtained so as to achieve the more positive shielding.

As shown in FIG. 1, a bracket 15, serving as a mounting portion, is formed integrally on an outer surface of a body 17 of the connector housing 49. The connector housing 49 can be mounted directly on a metal casing of an equipment (not shown) by fastening this bracket by a bolt. At this time, the shield connector 47 is mounted directly on the metal casing of the equipment while holding the connector housing 49 with the hand, and therefore the connector housing 49 is required to have a minimum necessary mechanical strength.

A distal end portion of the connector housing 49 is formed into an insertion portion 19 of a smaller diameter, and a mounting groove 21 for the O-ring 13 is formed in this insertion portion 19. When the insertion portion 19 is inserted into an insertion hole which is formed in the metal casing of the equipment, and is generally equal in diameter to this insertion portion 19, the O-ring 13, mounted in the mounting groove 21, forms a watertight seal between the insertion portion 19 and the insertion hole.

As shown in FIG. 2, an internal space of the connector housing 49 is divided into a smaller-diameter portion 3A, a medium-diameter portion 3B and a larger-diameter portion 3C which are arranged in this order from the distal end thereof (that is, from the lower side in FIG. 2), and are continuous with one another. The smaller-diameter portion 3A and the medium-diameter portion 3B serve as a receiving portion for receiving the short-circuiting member 5, and a front half portion of the larger-diameter portion 3C serves as a receiving portion for receiving the seal rubber 7 while a rear half portion thereof serves as a receiving portion for receiving the corrugated tube 9 and the corrugated tube holder 11.

A step portion, disposed at the boundary between the medium-diameter portion 3B and the larger-diameter portion 3C, serves as an abutment portion 25 for abutment against a flange 23 of the short-circuiting member 5. Two engagement holes 29, in which engagement claws 27 of the corrugated tube holder 11 are engaged, respectively, are formed in a wall defining the larger-diameter portion 3C.

As shown in FIG. 1, the short-circuiting member 5 has a generally cylindrical shape, and is open at its opposite ends, and a front half portion of this short-circuiting member defines a fixing body portion 31 while a rear half portion there of defines a press-fastening body portion 33. A plurality of spring piece portions 35 are formed by stamping on a peripheral surface of the fixing body portion 31, and the flange 23, having the same diameter as that of the medium-diameter portion 3B of the connector housing 49, is formed at an end edge of the press-fastening body portion 33 by pressing.

In FIGS. 1 and 2, the seal rubber 7 is a ring-like rubber plug, and a sheath 37D of a shielded wire 37 is passed through this seal rubber, and in this condition this seal rubber is received in the connector housing 49. An inner peripheral surface 39 and an outer peripheral surface 41 of the seal rubber 7 have a corrugated or wavy cross-section, and therefore can be positively held in intimate contact with the inner surface of the connector housing 49 and the sheath 37D of the shielded wire 37, respectively. The shielded wire 37 is of such a construction that conductors 37A, insulatingly covered with an inner covering 37B, are covered with a braid 37C, and this braid is covered with the sheath 37D in an insulated manner.

As shown in FIG. 1, the corrugated tube 9 is a bellows-like, soft cylindrical member, and is attached to the rear end portion of the connector housing 49 through the corrugated tube holder 11. This corrugated tube 9 can be bent in accordance with the bending of the shielded wire 37, and prevents the shielded wire 37 from being unduly bent in the vicinity of the connector housing 49, and besides protects the shielded wire 37 from the exterior.

As shown in FIG. 1, the corrugated tube holder 11 is split into two halves, that is, comprises a pair of half covers 11A and 11B. An engagement groove 43 of a corrugated cross-section for engagement with a bellows-like outer peripheral surface of the corrugated tube 9 is formed in inner surfaces of the half covers 11A and 11B. The engagement claws 27 for engagement in the engagement holes 29 in the connector housing 49 are formed or molded integrally on outer surfaces of the half covers 11A and 11B, respectively. When the half covers 11A and 11B are combined together into a unitary condition, their distal end surfaces jointly form a press contact surface 45 which is generally equal in diameter to the seal rubber 7.

In the shield connector 47 of the above construction, the shielded wire 37, subjected to end processing, is passed through the short-circuiting member 5, and the press-fastening body portion 33 is compressed to be fixed to the braid 37C, and when the shielded wire 37 is passed through the connector housing 49, the spring piece portions 35 of the short-circuiting member 5 are brought into contact with the smaller-diameter portion 3A of the connector housing 49 to be electrically connected thereto.

Then, the seal rubber 7, through which the shielded wire 37 is passed, is provisionally inserted into the connector housing 49, and then the shielded wire 37 is passed through an assembly comprising the corrugated tube 9 and the corrugated tube holder 11. The corrugated tube holder 11 is split into the two halves, that is, comprises the pair of half covers 11A and 11B, and when these half covers are combined together into a unitary condition, their distal end surfaces jointly form the press contact surface 45 which is generally equal in diameter to the seal rubber 7.

Then, this corrugated tube holder 11 is press-fitted into the larger-diameter portion 3C of the connector housing 49. Thereafter, the O-ring 13 is mounted in the mounting groove 21 in the connector housing 49, thus completing the assemblage.

When the bracket 15 of the connector housing 49 is mounted directly on the metal casing of the equipment (not shown), the braid 37C of the shielded wire 37 is connected for grounding purposes to the metal casing of the equipment via the short-circuiting member 5 and the connector housing 49.

Namely, the connector housing 49 of the shield connector 47 of this embodiment is obtained by producing the related connector housing 3 (see FIG. 3) using the metal composite material, comprising the lightweight metal 51 (such as aluminum, an aluminum alloy or a magnesium alloy) and the hollow ceramics grains 53 (of which cost is low), instead of aluminum. Mullite balloons, alumina balloons, carbon balloons, SiO₂ balloons or the like can be used as the hollow ceramics grains 53.

Examples of methods of producing the connector housing 49, using the metal composite material comprising the lightweight metal 51 and the hollow ceramics grains 53, include the following:

(1) A method in which hollow ceramics grains and molten lightweight metal are mixed together, and this mixture is cast.

(2) A method in which hollow ceramics grains are preformed into the shape of the connector housing 49, and then this preform is impregnated with molten lightweight metal.

(3) A method in which a lightweight metal billet, containing hollow ceramics grains, is beforehand formed, and this billet in a half-molten state is processed.

In view of the lightweight design of the connector housing 49 and its practical strength enough to perform its function, it has been confirmed through experiments that the proper content of the hollow ceramics grains 53 is about 30 to about 60 vol. % (the volume content of the hollow ceramics grains relative to the total volume of the connector housing: 30 to 60%).

Therefore, in the shield connector 47 according to this embodiment, the connector housing 49 is made of the metal composite material comprising the lightweight metal 51 (such as aluminum, an aluminum alloy or a magnesium alloy) and the hollow ceramics grains 53 which are lightweight and inexpensive. Therefore, the lightweight design can be achieved while securing the necessary mechanical strength, and besides the production cost can be reduced.

Therefore, the lightweight design of the electric vehicle can be achieved by using the shield connector 47 of the lightweight design.

The shield connector according to the present invention is not limited to the construction of the shield connector 47 of the above embodiment, and various forms can be adopted on the basis of the subject matter of the invention. Namely, the connector housing according to the invention can have various configurations in so far as the connector housing comprises the tubular body which includes the mounting portion for mounting directly on the metal casing of the equipment, and can be electrically connected to the braid of the shielded wire while covering the end portion of this shielded wire.

As described above, in the shield connector of the present invention, the connector housing is formed of the metal composite material comprising the lightweight metal and the hollow ceramics grains which are lightweight and inexpensive, and therefore the lightweight design can be achieved while securing the necessary mechanical strength, and besides the production cost can be reduced.

What is claimed is:

1. A shield connector for connecting a braid of a shielded wire to a metal casing of an equipment, the shield connector comprising:
a connector housing including,
a mounting portion for mounting directly on the metal casing, and
a tubular body capable of covering an end portion of the shielded wire so as to be electrically connected to the braid of the shielded wire,
wherein the connector housing is made of a metal composite material comprising lightweight metal and hollow ceramics grains.

2. The shield connector according to claim 1, wherein the volume content of the hollow ceramics grains relative to the total volume of the connector housing is 30% to 60%.

3. The shielded connector according to claim 1, wherein the connector housing is produced by a method in which the hollow ceramics grains and molten lightweight metal are mixed together, and the mixture is cast.

4. The shielded connector according to claim 1, wherein the connector housing is produced by a method in which the hollow ceramics grains are preformed into a shape of the connector housing, and the preform is impregnated with molten lightweight metal.

5. The shielded connector according to claim 1, wherein the connector housing is produced by a method in which a lightweight metal billet, containing the hollow ceramics grains, is beforehand formed, and the billet in a half-molten state is processed.
